(19) United States
(12) Patent Application Publication
(10) Pub. No.: US 2007/0201652 A1
(43) Pub. Date: Aug. 30, 2007

(54) Method And Telecommunications System For Providing Authorisation To A User During A Telephone Connection

(76) Inventor: Jan Bot, Nieuwendijk (NL)

Correspondence Address: ERICSSON INC., 6300 LEGACY DRIVE, M/S EVR 1-C-11, PLANO, TX, 75024, US

(21) Appl. No.: 10/596,533

(22) PCT Filed: Dec. 18, 2003
(86) PCT No.: PCT/EP03/14525

§ 371 Date: Jun. 15, 2006

(51) Int. Cl. H04M 1/56

(52) U.S. Cl. 379/142.05

(57) ABSTRACT

The invention relates generally to a method for providing an authorisation to a user during a telephone connection being established between a first user (A) and a second user (B) in a telecommunications system (10) comprising one or more inter-connected telecommunications networks (12-15), said method comprising the step of: i) setting up the telephone connection between both the first (A) and second user (B) using their subscriber identity numbers. The invention furthermore relates to a telecommunications system comprising one or more interconnected telecommunications networks (12-15), arranged for establishing a telephone connection between a first (A) and second user (B) using their subscriber identity numbers. According to the invention the method is further characterized by the steps of ii) receiving during the telephone connection being established a service request (11) from one of said first user (A) or second user (B); and iii) appointing based on said service request at least one authorization to said other of said first user (A) or second user (B). With these features it is possible for one of said parties involved to authorize during the telephone connection being established the other of said parties in performing other telecommunications services.

### FIELD OF THE INVENTION

The invention relates generally to a method for providing an authorisation to a user during a telephone connection being established between a first user and a second user in a telecommunications system comprising one or more interconnected telecommunications networks, said method comprising the step of:

i) setting up the telephone connection between both the first and second user using their subscriber identity numbers.

The invention furthermore relates to a telecommunications system comprising one or more interconnected telecommunications networks, arranged for establishing a telephone connection between a first user and a second user using their subscriber identity numbers.

Moreover the invention relates to an authorisation device in a telecommunications system, said telecommunications system comprising one or more interconnected telecommunications networks, arranged for establishing a telephone connection between a first user and second user using their subscriber identity numbers.

The invention also relates to storage means in a telecommunications network interconnected with other telecommunications networks in a telecommunications system arranged for establishing a telephone connection between a first user and second user using their subscriber identity numbers

The invention relates furthermore to a computer program product for use in a telecommunications system comprising one or more interconnected telecommunications networks arranged for establishing a telephone connection between a first user and second user using their subscriber identity numbers.

### BACKGROUND OF THE INVENTION

Modern telecommunications systems comprise a plurality of interconnected telecommunications networks, among others a wired or fixed telecommunications network, such as the Public Switched Telecommunications Network (PSTN) or the Integrated Services Digital Network (ISDN), and wireless cellular radio or mobile telecommunications networks, such as operating in accordance with the Global System for Mobile communications (GSM), for example.

The above described method for setting up a telephone connection between a first user, for example a calling party and a second user, for example a called party is generally known and widespread. In general the unique subscriber identification numbers of the calling party and called party are used for setting up an telephone connection via a plurality of interconnected telecommunications networks.

At this moment no provisions are known or implemented in the present telecommunications systems allowing one of the parties involved to give an specific authorisation to the other party for the future. With the implementation or use of so-called Calling Line Identification Presentation a called party is able to recognize the identity of the calling party and thus decide whether the telephone call has to be accepted or not, without picking up the receiver of his telephone.

However this approach is only beneficial to one of said parties in the event the calling party is already known to him. Moreover it requires moreover an address book maintained and stored locally in a specific telephone receiver.

Furthermore it common practise that the incoming phone number being recognized does not correspond with the subscriber identity number of the calling party.

### SUMMARY OF THE INVENTION

It is an object of the present invention to provide an improved method for providing an authorisation to a user during a telephone connection between two parties, wherein one of said parties has the ability in authorise the other party for setting up or performing additional telecommunication services.

It is another object of the invention to provide a telecommunications system capable of performing the method according to the invention.

This object is achieved as the method according to the invention is further characterized by the steps of

ii) receiving during the telephone connection being established a service request from one of said first user or second user; and

iii) appointing based on said service request at least one authorization to said other of said first user or second user.

With these features it is possible for one of said parties involved to authorise during the telephone connection being established the other of said parties in performing other telecommunications services.

In one embodiment of the method according to the invention said authorization comprises the step of

iv) preventing based on said authorization the establishment of a future telephone connection between said first user and second user by said other of said first user or second user.

With this barring facility it is no longer necessary to forward the subscriber identity number of the party involved toward malicious call barring service after the telephone connection has been terminated as often the subscriber identity number of the party to be barred is lost once the telephone connection is terminated or said subscriber identity number differs from the incoming phone number being recognized.

According to another aspect of the invention said authorization may comprise the step of

v) allowing based on said authorization the establishment of a future telephone connection between said first user and second user by said other of said first user or second user.

Furthermore according to another aspect of the method according to the invention said authorization comprises the step of

vi) allowing based on said authorization said other of said first user or second user access to information sources kept by said one of said first user or second user.

According to yet another aspect of the method according to the invention said authorization comprises the step of

vii) allowing based on said authorization said other of said first user or second user to provide information to said one of said first user or second user.

Hence with these aspects is it possible to authorise the calling party in allowing or preventing the execution of certain telecommunication services.

According to an advantageous embodiment the method uses the further step of

viii) entering upon receipt of said service request from said one of said first user or second user the subscriber identity number corresponding with said other of said first user or second user on at least one authorization list; and

ix) consulting said authorization list when a future telephone connection is being set up by said other of said first user or second user.

This allows a timely identification of the calling party and appointing the authorisation mentioned in said authorisation list.

More in particular in the method according to the invention said subscriber identity number corresponds with the first user or with the second user.

The telecommunications system according to the invention is characterized in that at least one of said interconnected telecommunications networks is arranged in receiving a service request during the telephone connection being established from one of said first user or second user; and

is arranged in appointing based on said service request at least one authorization to said other of said first user or second user.

In a further embodiment the telecommunications system according to the invention is characterized in that said at least one of said interconnected telecommunications networks is arranged in allowing based on said authorization the establishment of a future telephone connection between said first user and second user by said other of said first user or second user, as well as that said at least one of said interconnected telecommunications networks is arranged in allowing said other of said first user or second user access to information sources kept by said one of said first user or second user or said at least one of said interconnected telecommunications networks is arranged in to provide information to said one of said first user or second user.

More in particular said at least one of said interconnected telecommunications networks is arranged in entering upon receipt of said service request from said one of the first or second user the subscriber identity number corresponding with said other of the first or second user on an authorization list; and

at least one of said interconnected telecommunications networks is arranged in consulting said authorization list each time a future telephone connection is being set up by said other of the first or second user.

According to a specific advantageous embodiment said list is contained in a database present in said at least one of said interconnected telecommunications networks.

Furthermore said interconnected telecommunications networks are arranged in synchronizing their respective lists allowing to exchange the identity of notorious telephone stalkers throughout the telecommunications system.

The telecommunications network is according to the invention arranged in receiving a service request during the telephone connection being established from one of said first user or second user; and

is arranged in appointing based on said service request at least one authorization to said other of said first user or second user.

In a specific embodiment said telecommunications network is arranged in entering upon receipt of said service request from said one of the first or second user the subscriber identity number corresponding with said other of the first user or second user on an authorization list; and

in consulting said authorization list each time a future telephone connection is being set up by said other of the said first user or second user.

According to another aspect of the invention the authorisation device is arranged in receiving a service request during the telephone connection being established from one of said first user or second user; and

is arranged in appointing based on said service request at least one authorization to said other of said first user or second user.

Furthermore the storage means according to the invention are capable of arranging and maintaining a database containing an authorization list and are capable in entering upon receipt of a service request from said one of the first user or second user the subscriber identity number corresponding with said other of the said first user or second user on said authorization list.

Yet another aspect of the invention concerns a computer program product comprising software code means which, when run on a computer causes the method according the invention.

### BRIEF DESCRIPTION OF THE DRAWING

The invention will now be described in more detail using the accompanying drawing, which shows in:

FIG. 1 a flow chart describing an embodiment of a method according to the invention;

FIG. 2 a flow chart describing another embodiment of a method according to the invention;

FIG. 3 an embodiment of a telecommunications network according to the invention (schematically).

### DETAILED DESCRIPTION OF THE DRAWING

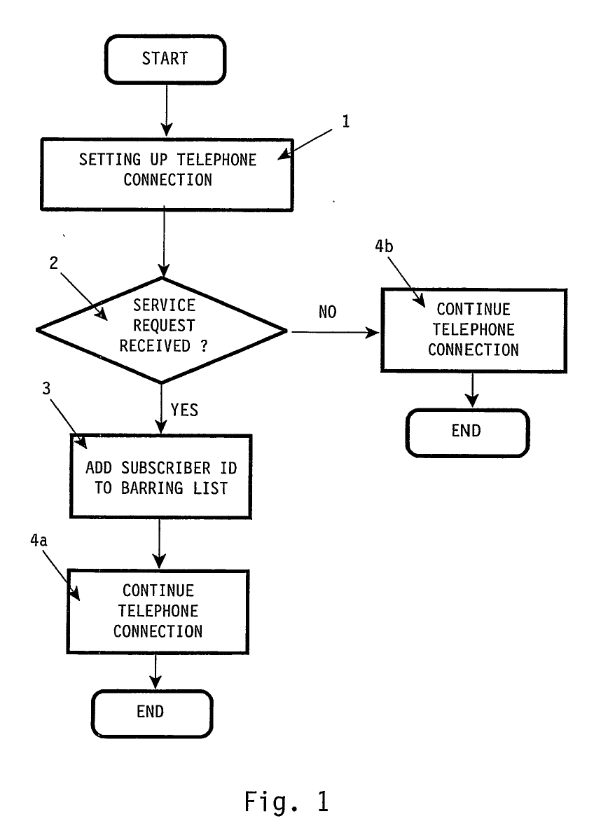

FIG. 1 shows a flow chart depicting a method according to the present invention. The method according to the invention enables one of said calling or called party in giving an authorisation to the other party for setting up a telephone connection.

A calling party usually initiates the setting up of a telephone connection with a called party by picking up the receiver of his telephone set and dialing the phone number corresponding with said called party. The setting up of the telephone connection in a telecommunications system comprising one or more interconnected telecommunications networks uses the subscriber identification number of the calling party as well as of the called party (Step 1 of FIG. 1). Once the telephone connection is established communication between the both parties is possible, for example via a duplex speech connection.

The method according to the invention allows one of the calling or called party to invoke a service request during the telephone connection being set up, for example by pressing or selecting a predefined service invocation number using the local telephone set (Step 2). Said service request is received by one of said interconnected telecommunications networks, which network is according to the invention arranged to add the subscriber identification number of the party on a specific authorisation list (Step 3).

Once the service request is received by said interconnected telecommunications network in Step 2, then the telephone connection between the calling party and the called party is continued in Step 4a and communication between the both parties remains possible, for example via a duplex speech connection.

If no service request is received by said interconnected telecommunications network in Step 2, then the telephone connection between the calling party and the called party is continued in Step 4b and communication between the both parties remains possible, for example via a duplex speech connection.

Once the subscriber identification number of the party is added to the list in Step 3, said party is given a specific authorisation for future actions, for example future telephone calls in relation to the other party (user), who has entered said subscriber identification number on said authorisation list. It is noted that in this application the authorisation given to said party by said other party has to be interpreted in terms of “permission” or “sanction”.

In general the subscriber identification number of the party to be given a specific authorisation is added by the other party to a specific authorisation list contained in one of said interconnecting telecommunications networks as invoked by pressing or selecting a predefined service invocation key or sequence of keys on the local telephone set.

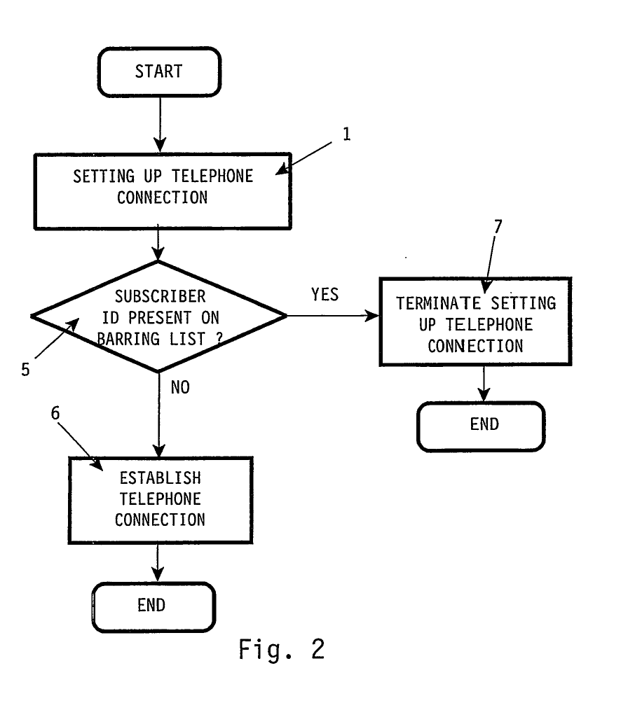

An example of the method according to the invention where the authorisation given has to be interpreted as a sanction is depicted in FIG. 2.

To this end the method according to the invention can be arranged in consulting said authorisation list (Step 5) once a next telephone connection is being set up (Step 1) between both calling and called parties. Once it is determined that the subscriber identification number of the calling party is present on said authorisation list the method according to the invention examines said authorisation and based on said examination the method may perform a specific action in relation to said party present on said authorisation list.

One authorisation may concern a sanction, e.g. preventing based on said examination of the authorisation the setting up of said telephone connection between both parties via the respective interconnected telecommunications networks (Step 7).

The authorisation list present in one of said interconnected telecommunications networks has to be interpreted as a barring list in this embodiment of the method according to the invention barring or preventing the establishment of a telephone connection between two parties as set up by one of said parties present on said barring list.

If after consultation in Step 5, it is determined that the subscriber identification number of the calling party is not present on said authorisation list the method according to the invention continues with setting up the telephone connection until said connection is established and communication between the both parties becomes possible, for example via a duplex speech connection.

Likewise the authorisation list contained in one of said interconnected telecommunications networks can involve the allowance of said calling party in setting up a telephone connection with said called party.

In another embodiment of the method according to the invention the authorisation list contained in one of said interconnected telecommunications networks can involve the allowance in providing information inputted by said calling party for the benefit of said called party, for example for purchasing goods via telephone.

In another embodiment of the method according to the invention the authorisation list contained in one of said interconnected telecommunications networks can involve the allowance in providing said calling party access to certain information sources kept by said called party, for example a database or a website on the Internet.

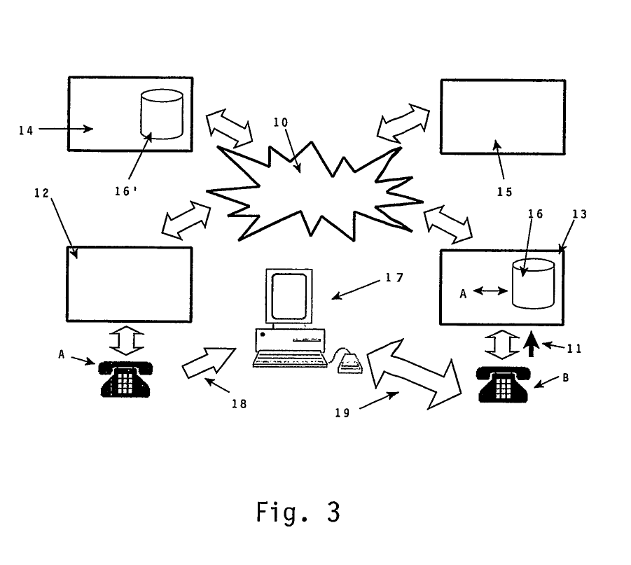

In FIG. 3 a first embodiment of a telecommunications system according to the invention is depicted schematically with reference numeral 11, wherein the telecommunication system 11 consists of one or more interconnected telecommunications networks 12-15. In each interconnected telephone system a subscriber A and B respectively are present in one of said interconnected telecommunications networks 12 and 13 respectively.

In the event a telephone connection is being set up between party A and party B via their local interconnected telecommunications network 12, the telecommunications system 11, and the local interconnected telecommunication network 13, the telecommunications system is according to the invention arranged in receiving a service request (depicted with reverence numeral 11) invoked by for example the called party B. Based on said invoked service request said interconnected telecommunication network 3 is arranged in adding the subscriber identification number of said calling party A on an authorisation list, for example maintained in a database 16.

As discussed above said authorisation list contains all kinds of authorisations associated to the subscriber identification number of certain calling parties, who have been added to said list 16 by said called party B. These authorisations may have a positive (that is an “allowing”) nature or a negative nature (that is a “sanction”).

A sanctionable authorisation may involve the prevention of the setting up of a future telephone connection between the calling party A and said called party B.

In FIG. 3 said service request being invoked by, here the called party B, is depicted with reference numeral 11. The invoked service request 11 will add the subscriber identification number A corresponding with the identity of the calling party A to a list 16 contained in, kept in and maintained by said interconnected telecommunications network 13.

Hence, in the event that a future telephone connection is established with said called party B by said barred calling party A, said interconnected telecommunications network 13 is arranged in verifying said subscriber identification number A of the calling party A with the contents of the list 16 contained in said interconnected telecommunications network 13.

Once it is verified that the subscriber identification number of the calling party A is present on the barring list 16, the telecommunication system according to the invention is arranged in terminating the setting up of the telephone connection between the calling party A and called party B.

Although the telecommunications system according to the invention is primarily intended in barring future telephone connections between a barred party and another party it is also possible to perform other telecommunications services between the parties involved, for example in allowing the establishment of a telephone connection between party A and B or in allowing the calling party A based on the authorisation given access to certain information sources kept by said called party B.

In FIG. 3 this embodiment of the method and the telecommunications system according to the invention is depicted with reference numeral 17, being schematically a computer/server on which a internet website is maintained by party B (double arrow 19). The authorisation given to the calling party A by said party B by entering (reference numeral 11) the subscriber identification number of party A on said authorisation list 16 means the allowance of consulting the website 17 by party A via an internet connection (single arrow 18).

In another embodiment the invoked service request 11 as initiated by said called party B may result in forwarding the telephone connection being set up by the calling party A to a call centre service using a specific dedicated service number, where the authorisation list 16 is maintained and updated.

In a specific embodiment multiple interconnected telecommunication networks 12-15 each may comprise a database containing a list 16-16′ with the subscriber identification numbers of parties to be barred, which different databases 16-16′ may be synchronized in order to obtain a more effective barring technique.

Although not shown in FIG. 3 in said telecommunications system 10 an authorisation device may be present which is according to the invention arranged in receiving the service request during the telephone connection being established from one of said first user or second user; and is arranged in appointing based on said service request at least one authorization to said other of said first user or second user.

Hence in this embodiment the authorisation device acts on behalf of the several interconnected telecommunications networks 12-13-14-15 in the telecommunications system 10 and is arranged in implementing the method according to the invention depending on the authorisation being given. This means that the authorisation device—on behalf of the several interconnected telecommunications networks 12-13-14-15—may cause the establishment of a future telephone connection between said first user and second user by said one of said first user or second user.

Also based on said authorization, the authorisation device may allow the establishment of a future telephone connection between said first user and second user by said other of said first user or second user, or may allow said other of said first user or second user access to information sources kept by said one of said first user or second user, or even may allow said other of said first user or second user to provide information to said one of said first user or second user.

Said authorisation device can also be arranged in entering upon receipt of said service request from said one of said first user or second user A-B the subscriber identity number corresponding with said other of said first user or second user on at least one authorization list contained and maintained in said device and consulting said authorization list when a future telephone connection is being set up by said other of said first user or second user A-B.

In another embodiment said list can also be maintained in storage means present in said telecommunications system 10 or in one of said interconnected telecommunications networks 12-13-14-15, which storage means are capable of arranging and maintaining a database containing said authorization list and which storage means are capable in entering upon receipt of a service request from said one of the first user or second user A-B the subscriber identity number corresponding with said other of the said first user or second user A-B on said authorization list.

To this end a computer software program may be used by said storage means or by said authorisation device or by one of said interconnected telecommunications networks, said program comprising software code means which, when run on a computer causes the method of any one of the aspects of the invention as described in this patent application to be performed.

1. A method for providing an authorization to a user during a telephone connection being established between a first user and a second user in a telecommunications system comprising one or more interconnected telecommunications networks, said method comprising the steps of:
i) setting up the telephone connection between both the first and second user using their subscriber identity numbers based on authorizations appointed to said first or second user;
ii) receiving during the telephone connection being established a service request from one of said first user or second user; and
iii) appointing based on said service request received during the telephone connection being established at least one authorization to said other of said first user or second user.

2. The method according to claim 1, wherein said authorization comprises the step of
iv) preventing based on said authorization the establishment of a future telephone connection between said first user and second user by said one of said first user or second user.

3. The method according to claim 1, wherein said authorization comprises the step of
v) allowing based on said authorization the establishment of a future telephone connection between said first user and second user by said other of said first user or second user.

4. The method according to claim 1, wherein said authorization comprises the step of
vi) allowing based on said authorization said other of said first user or second user access to information sources kept by said one of said first user or second user.

5. The method according to claim 1, wherein said authorization comprises the step of
vii) allowing based on said authorization said other of said first user or second user to provide information to said one of said first user or second user.

6. The method according to claim 1, further comprising the step of
viii) entering upon receipt of said service request from said one of said first user or second user the subscriber identity number corresponding with said other of said first user or second user on at least one authorization list; and
ix) consulting said authorization list when a future telephone connection is being set up by said other of said first user or second user.

7. A telecommunications system comprising one or more interconnected telecommunications networks, arranged for establishing a telephone connection between a first user and second user using their subscriber identity numbers based on authorizations appointed to said first or second user, wherein at least one of said interconnected telecommunications networks
is arranged in receiving a service request during the telephone connection being established from one of said first user or second user; and
is arranged in appointing, based on said service request, at least one authorization to said other of said first user or second user.

8. The telecommunications system according to claim 7, wherein said at least one of said interconnected telecommunications networks is arranged in preventing, based on said authorization, the establishment of a future telephone connection between said first user and second user by said one of said first user or second user.

9. The telecommunications system according to claim 7, wherein said at least one of said interconnected telecommunications networks is arranged in allowing, based on said authorization, the establishment of a future telephone connection between said first user and second user by said one of said first user or second user.

10. The telecommunications system according to claim 7, wherein said at least one of said interconnected telecommunications networks is arranged in allowing said other of said first user or second user access to information sources kept by said one of said first user or second user.

11. The telecommunications system according to claim 7, wherein said at least one of said interconnected telecommunications networks is arranged in to provide information to said one of said first user or second user.

12. The telecommunications system according to claim 7, wherein said at least one of said interconnected telecommunications networks is arranged in
entering, upon receipt of said service request from said one of the first user or the second user, the subscriber identity number corresponding with said other of the said first user or second user on an authorization list; and
at least one of said interconnected telecommunications networks is arranged in consulting said authorization list each time a future telephone connection is being set up by said other of the first user or second user.

13. The telecommunications system according to claim 12, wherein characterized in that, said authorization list is contained in a database present in said at least one of said interconnected telecommunications networks.

14. The telecommunications system according to claim 12 or 13, wherein said interconnected telecommunications networks are arranged in synchronizing their respective lists.

15. A telecommunications network interconnected with other telecommunications networks in a telecommunications system, arranged for establishing a telephone connection between a first user and second user using their subscriber identity numbers based on authorizations appointed to said first or second user, said telecommunications network
is arranged in receiving a service request during the telephone connection being established from either one of said first user or second user; and
is arranged in appointing, based on said service request, at least one authorization to another of said first user or second user.

16. The telecommunications network according to claim 15, wherein characterized in that, said telecommunications network is arranged in
entering, upon receipt of said service request from said one of the first or second users the subscriber identity number corresponding with said another of the first user or second user on an authorization list; and
in consulting said authorization list each time a future telephone connection is being set up by said other of the said first user or second user.

17. An authorisation device in a telecommunications system, said telecommunications system comprising one or more interconnected telecommunications networks, arranged for establishing a telephone connection between a first user and second user using their subscriber identity numbers, said authorisation device being arranged in
receiving a service request during the telephone connection being established from one of said first user or second user; and
is arranged in appointing based on said service request at least one authorization to another of said first user or second user.

18. Storage means in a telecommunications network interconnected with other telecommunications networks in a telecommunications system arranged for establishing a telephone connection between a first user and second user using their subscriber identity numbers based on authorization appointed to said first or second user, characterized in that said storage means capable of arranging and maintaining a database containing an authorization list and entering, upon receipt of a service request from said one of the first user or second user, the subscriber identity number corresponding with another of said first user or the second user on said authorization list.

19. (canceled)
